(19) United States
(12) Patent Application Publication
(10) Pub. No.: US 2017/0308120 A1
(43) Pub. Date: Oct. 26, 2017

(54) Docking Station for Blade Computing Device

(71) Applicant: HEWLETT PACKARD ENTERPRISE DEVELOPMENT LP, Houston, TX (US)

(72) Inventors: Niraj NAIDU, Rhodes (AU); Daniel Jorge BIONDI, Sydney (AU)

(21) Appl. No.: 15/511,640

(22) PCT Filed: Sep. 30, 2014
(86) PCT No.: PCT/US2014/058279

§ 371 Date: Mar. 16, 2017

(51) Int. Cl. G06F 1/16; G06F 1/26; G06F 1/18; G06F 1/32; G06F 1/20

(52) U.S. Cl. CPC G06F 1/1632; G06F 1/3287; G06F 1/20; G06F 1/181; G06F 1/266; G06F 2200/1635; G06F 2200/1638

(57) ABSTRACT

A docking station for a blade computing device includes a power supply, a cooling system, a communication interface to connect the docking station to an external device and an electrical connector to connect the docking station to a blade computing device.

### BACKGROUND

A rack computing device is a computing device, such as a server, switch or storage device that is designed to be mounted to a rack. A plurality of rack computing devices may be mounted to rack one above the other. A rack computing device may have its own power supply and cooling fan and thus may operate independently of the rack to which it is mounted.

A blade computing device (hereinafter also referred to as a ‘blade’) is a computing device such as a server, switch or storage device that is designed to fit into a blade enclosure, together with a plurality of other blade computing devices. The blade enclosure includes a power supply and cooling fans. The blades may thus rely on the enclosure for power and cooling and may thus be more compact than a standard rack computing device.

### BRIEF DESCRIPTION OF THE DRAWINGS

Examples of the disclosure will now be described, by way of non-limiting example only, with reference to the accompanying drawings, in which:

FIG. 1 is a perspective view from the front of a docking station according to an example;

FIG. 2 is a view from the side of a docking station according to an example;

FIG. 3 is a view from the side of a docking station and a blade computing device being mounted to the docking station according to an example;

FIG. 4 is a perspective view from the front of a blade computing device mounted to a docking station according to an example;

FIG. 5 is a view from the front of a full height blade computing device mounted to a docking station according to an example;

FIG. 6 is a view from the front of a half height blade computing device mounted to a docking station according to an example;

FIG. 7 is a schematic view from the side showing the internal configuration of a docking station according to an example;

FIG. 8 shows a full height blade computing device mounted to the docking station of FIG. 7 according to an example;

FIG. 9 shows a half height blade computing device mounted to the docking station of FIG. 7 according to an example;

FIG. 10 is a schematic view from the front of a docking station and related circuitry according to an example;

FIG. 11 is a close up schematic view of a locking feature and a sensor according to an example; and

FIG. 12 is a schematic view of the rear of a docking station according to an example.

### DETAILED DESCRIPTION

A blade computing device includes at least a circuit board including a processor, a volatile memory, I/O circuitry and an electrical connector for connecting the blade to the blade enclosure. In some cases, the blade may also include a non-volatile storage such as a hard disk and/or other components such as application specific integrated circuits (ASICs) or other specialized chips. The blade does not include its own power supply and has limited or no cooling functionality. In one example a blade may have cooling fins attached directly on top of a central processing unit (CPU) of the blade, but not have a fan unit for moving air in and out of the blade housing. Thus for normal operational use the blade is mounted to a blade enclosure and the blade enclosure provides cooling and power.

A blade enclosure is designed to receive a plurality of blades. In that way many blades may be hosted in a relatively small space. A full height blade is a blade that can fit into a single slot of a blade enclosure. A half height blade has approximately half the height such that two half height blades can fit into the same space. While the exact size may vary from vendor to vendor a full height blade generally has a height of less than 19 inches and a half height blade generally has a height of less than 9 inches.

As a blade relies an an enclosure for power and cooling it can be difficult to demonstrate the blade to a customer who does not already have a suitable blade enclosure. Furthermore, if a blade malfunctions it may need to be removed from the blade enclosure for inspection. It can be difficult and uncomfortable for an engineer to examine and test the blade in a data center, especially if the testing will take some time or the data center is hot or has limited space for such activity.

Accordingly the present disclosure proposes a docking station for a blade computing device. The docking station includes a power supply, a cooling system, a communication interface to connect the docking station to an external device and an electrical connector to connect the docking station to a blade computing device. A blade computing device may thus be mounted to the docking station and examined, demonstrated or used outside of a blade enclosure. A blade is said to be mounted to a docking station when it is physically supported by the docking station and connected to an electrical connector and/or a cooling system of the docking station.

In one example the docking station is portable. By portable it is meant that when a blade is not mounted to the docking station, the docking station is of a size and weight such that is easy for an engineer or sales person to pick up the docking station and carry it from place to place.

In another example the docking station is not capable of supporting more than one full height blade. Such a docking station is smaller and lighter than a typical blade enclosure. A typical blade enclosure is designed to support two or more full height blades and in some cases as many as eight full height blades.

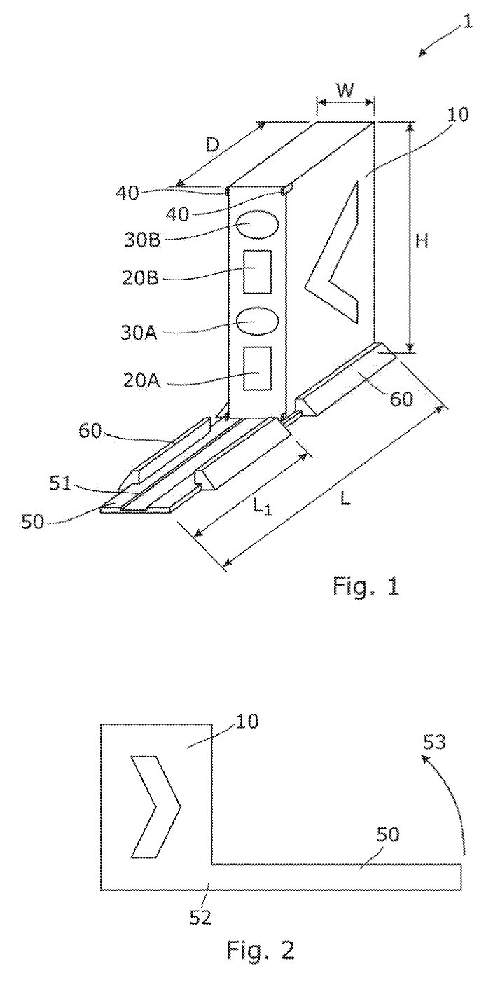

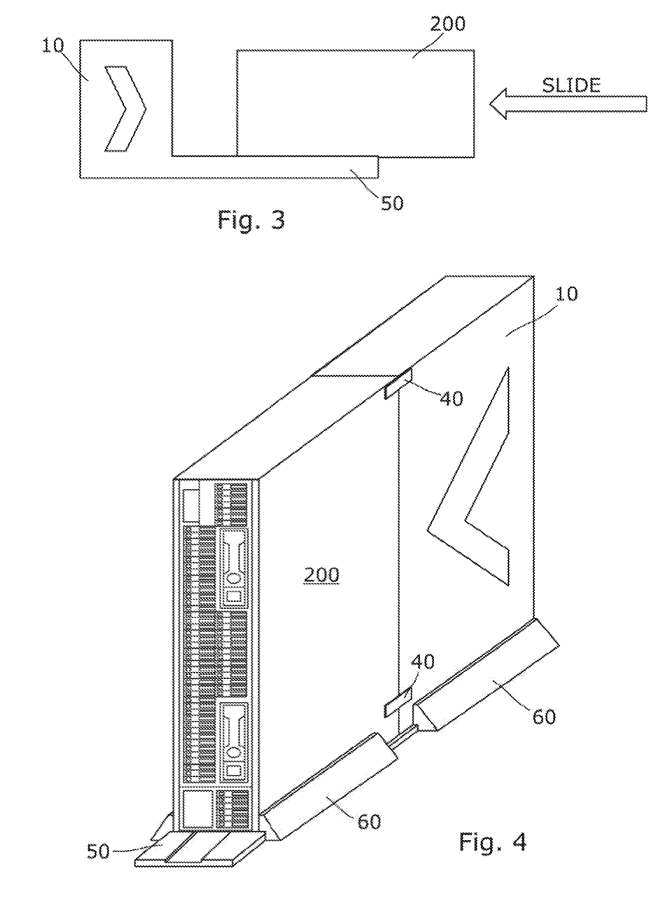

FIG. 1 is a perspective view of an example docking station as seen from the front. The docking station includes a main body 10 and a support platform 50 extending from the main body. FIG. 2 shows a view of the docking station from the side. FIG. 3 is another view from side that shows how a blade 200 may be placed on the support platform 50 and slid into place so that it mates with the main body 10 of the docking station as shown in FIG. 4.

The main body 10 houses a power supply and a cooling system as will be explained in more detail later. A blade is said to be mounted to the docking station when it is physically supported by the docking station and connected to an electrical connector and/or a cooling system of the docking station. By connecting the blade to the electrical connector and the cooling system, the blade is able to function while mounted to the docking station. The blade is not said to be mounted to the docking station if it is physically supported, but not connected to an electrical connector and/or cooling system of the docking station.

The number and position of electrical connectors will vary depending upon the blade which the docking station is designed for. In the specific example shown in FIG. 1, an external wall of the main body includes a first electrical connector 20A and a second electrical connector 20B. In other examples there may be one electrical connector or may be more than two electrical connectors. Both of the electrical connectors in this example are integrated connectors which are to convey both electrical power and communication signals. In other examples the electrical power and communication signals may be conveyed by separate electrical connectors. In still other examples the docking station may have a plurality of electrical connectors, each electrical communication connector to convey a different type of communication such as Ethernet, Fiber Channel etc.

The cooling system may interact with a mounted blade via an aperture in the main body through which a coolant may be directed to a mounted blade or drawn through the blade. In the example shown in FIG. 1 there is a first aperture 30A and a second aperture 30B each of which is to align with a respective aperture in the casing of a full height blade server. The exact number and position of apertures, which are act as cooling channel inlets or outlets, will depend upon the type of blade which the docking station is designed to receive.

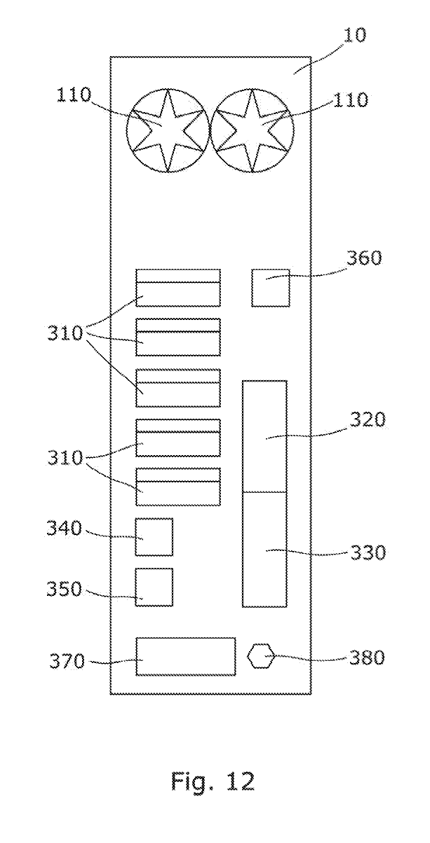

The docking station also has a communication interface or communications interfaces for sending and/or receiving signals to an external device other than a blade computing device. For instance the communication interface may include I/O ports such as for video, keyboard and mouse, network connections such as Ethernet or Fiber Channel etc. The communication interfaces (not shown in FIG. 1) may be provided on any external wall of the main body 10. In one example the communication interfaces are on the rear wall of the main body. An example of a rear wall with communication interfaces is shown in detail in FIG. 12.

In the arrangement shown in FIGS. 1 to 4 the support platform extends outwardly in front of the main body of the docking station. However, the support platform may be retractable against or into the main body. For instance the support platform 50 may have a hinged connection 52 to the main body so that it can be retracted by folding up against the main body in direction shown by arrow 53 in FIG. 2. In another example, instead of being hinged, the support platform 50 may be retracted by sliding back into a base of the main body. In still other examples the support platform may be fixed and not retractable. However, when the support platform is retractable it enables the docking station to be packed into a more compact unit which is easier to carry.

A blade computing device is typically quite heavy, thin and fairly dense. This can make a blade computing device unstable when rested on its side. The support platform has a surface on which the blade may be rested, which helps to stabilise the blade. The support platform may have a slot 51 which helps to guide the blade when it is being mounted to the main body and the slot may also help to hold the blade in place. Further the docking station may have a locking feature or several locking features to secure the blade to the docking station as will be discussed in more detail later.

The docking station may have stabiliser feet 60 extending on both sides of the main body and/or on both sides of the support platform. The stabiliser feet help to stabilise the docking station and may help to prevent it from toppling over.

The docking station is portable so that it can easily be carried from place to place by a person. In one example the docking station weighs 2.5 kg or less. This is in contrast to some known blade enclosures that may weigh 59 kg, 106 kg or more.

In terms of dimensions, the main body 10 of the docking station has a height H, a width W and a depth D as shown in FIG. 1. The support platform has a length L₁ which combines with the depth of the main body D to a length L when the support platform extends in front of the main body. The length L₁ of the support platform is at least as long as a depth of the blade which it is designed to support. The dimensions of the main body may vary according to the design. In one example, the height H and width W of the main body may be similar to the height of the tallest blade which it the docking station is designed to support. In one example the depth D of the main body is similar to the length of the support platform. In one example the main body of the docking station has a height of less than 21 inches, a depth of less than 15 inches and a width of less than 3 inches. In another example the main body of the docking station has a height of approximately 40 cm (15.75 inches), a 37 cm (14.57 inches) and a width of 12 cm (14.72 inches).

The stabiliser feet may have any size. In one example each stabiliser foot has a width W1 which is at least 25% of the width W of the main body. The main body 10, support platform 50 and stabiliser feet 60 may he formed of any appropriate material. In one example a light weight material such as plastic is used. In one example the stabiliser feet 60 may be formed from a material which is heavier and more dense than materials used for the main body. This may help to further stabilise the docking station by increasing the portion of the weight which as at the base. In another example the base of the main body may also be made of a denser material.

In the examples shown in FIGS. 1 and 4, the main body and support platform are such that when a blade is mounted to the docking station, the blade is substantially exposed to the environment external to the docking station. The bottom of the blade rests on the support platform and one end of the blade abuts the main body, but otherwise the blade is relatively exposed. The support platform may have no sidewalls or relatively low sidewalls and there is no wall covering the top of the blade. This helps to keep the weight of the docking station relatively low and the size relatively compact making it easier for users to carry from place to place.

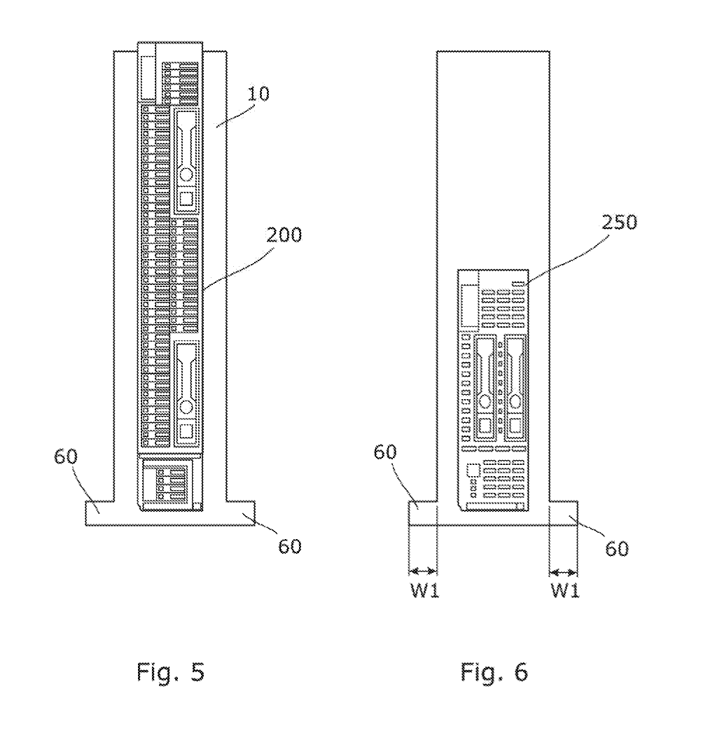

The docking station is designed to be able to support a single half or full height blade computing device. In one example the docking station is not able to support more than one full height blade computing device. That is the docking station has insufficient size to physically support and/or insufficient blade connectors or cooling capacity to support more than one full height blade. FIG. 5 is a front view of an example in which a full height blade 200 is mounted to the docking station. The docking station may be able to support a single half height blade 250 instead and a front view of this is shown in the example of FIG. 6. It would be possible to have a docking station that was able to support a single half height blade and too small to support a full height blade server; such a docking station is within the scope of the present disclosure. However, a docking station as shown in FIGS. 5 and 6 that is able to support either a single full height blade or a single half height blade is more flexible and has a wider range of use.

In some examples it would be possible for a docking station to support either a single full height blade, or a single half height blade or to support two half height blades simultaneously. The phrase “the docking station is not able to support more than a single full height blade” is intended to cover each of these three possibilities. However, in many cases a docking station able to support either a single full height blade or a single half height blade will be sufficient for repair, inspection or product demonstration purposes.

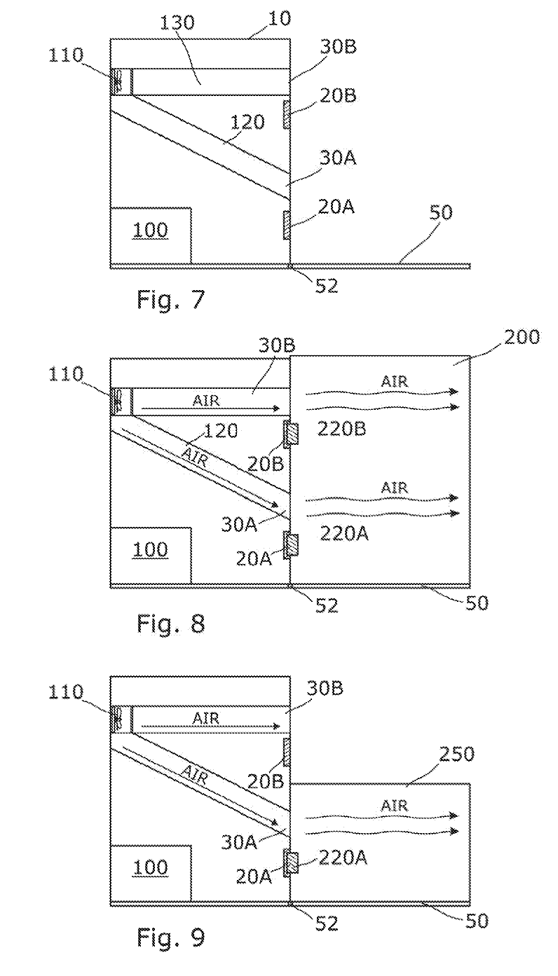

FIG. 7 is a schematic view showing the internal design of an example docking station. The main body 10 houses a power supply 100 and a cooling system which includes a pair of fans 110. A first fan is associated with a first cooling channel 120, while the second fan is associated with a second cooling channel 130. The cooling channel 120 extends between the first fan and the first cooling aperture 30A, while the second cooling channel 130 extends between the second fan and a second cooling aperture 30B. The fans blow air through their respective cooling channels to cool a blade which is mounted to the docking station as shown in FIG. 8. That is the apertures 30A, 30B align with respective apertures in the blade 200. In another example the fans could operate in the opposite direction to suck air through the blade and through the cooling channels 120, 130. In another example, a bi-directional fan may both blow and suck air through each of the cooling channels. In one example the cooling channels are pipes that form enclosed channels. While using fans and air as a coolant for blade computing devices is more common, in still another example the cooling system may employ a liquid coolant and have pumps instead of fans.

The power supply may be connected to the fans 110 and to the electrical connectors 20A, 20B. For instance the power supply may be connected to the electrical connectors 20A, 20B via a midplane (not shown). The midplane may also connect the electrical connectors 20A, 20B to the communication interface of the docking station, e.g. a communication interface on the rear of the main body as shown in FIG. 12, so as to allow communication signals to be passed between the communication interface and a blade connected to the electrical connector.

FIG. 8 shows a full height blade server 200 which has first and second electrical connectors 220A, 220B which are to connect to electrical connectors 20A, 20B of a blade enclosure. When mounted to the docking station, these electrical connectors 220A, 220B connect respectively to the first and second electrical connectors 20A, 20B of the main body of the docking station. In other examples a full height blade server may have more or fewer than two electrical connectors and the positioning may be different, in which case the docking station may have more or fewer electrical connectors and the position may be different.

FIG. 9 shows a half height blade computing device 250 which is mounted to the docking station. In this example the half height blade computing device 250 has a single electrical connketor 220A which connects to the docking station's first electrical connector 20A and a single cooling aperture 220A which aligns with the first cooling aperture 30A of the docking station. The second electrical connector 20B and the second cooling aperture 30B of the docking station are above the height of the mounted half height blade 250 and do not connect with the blade. In other examples there may be more or fewer electrical connectors and apertures and the positioning may be different.

The docking station includes circuitry to detect whether a full height blade or half height blade is mounted to the docking station and to turn on the first fan in response to detecting that a half height blade computing device is mounted to the docking station and to turn on both the first fan and the second fan in response to determining that a full height blade computing device is mounted to the docking station. In this way when a half height blade is mounted to the docking station as shown in FIG. 9, air is not blown or sucked through the second cooling channel 130, as the second fan is not turned on.

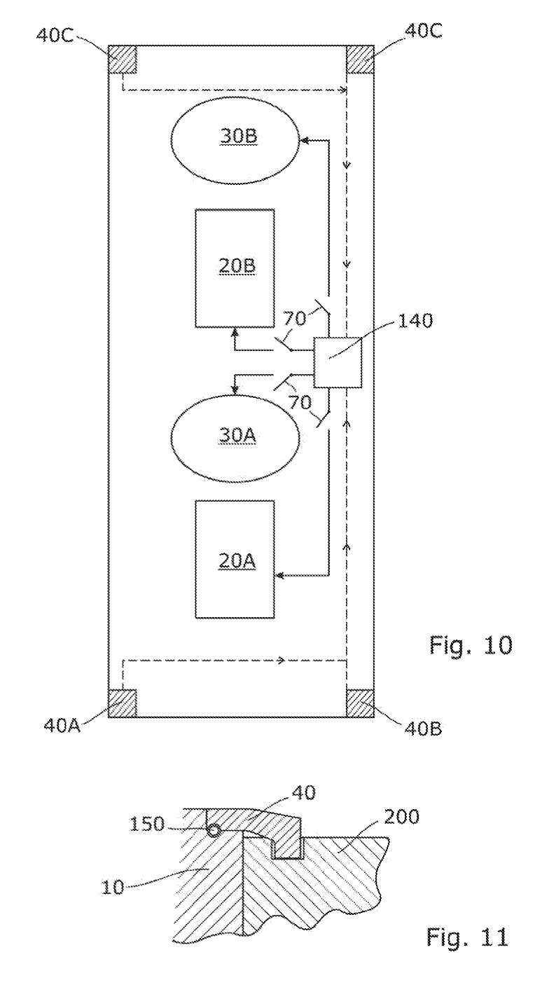

FIG. 10 is a schematic view of a front of the main body of the docking station and also shows the aforementioned circuitry in schematic form. There are apertures 30A and 30B associated with first and second cooling channels and first and second fans as mentioned above. There are also first and second electrical connectors 20A and 20B as mentioned above. The electrical connectors may convey power and/or communication signals to a blade mounted to the docking station. The circuitry may include a sensor or several sensors to detect whether a blade mounted to the docking station is a full height blade or a half height blade and controller 140 to switch switches 70 to turn on the first fan and connect the first electrical connector to the power supply when a half height blade is mounted. The controller may switch switches 70 to turn on both the first fan and the second fan and connect both the first electrical connector 20A and the second electrical connector 20B to the power supply when the sensor or sensors indicate that a full height blade is mounted to the docking station.

In one example each switch 70 may be associated with a respective fan or electrical connector and the controller 140 and the controller 140 may switch on or off a switch 70 to turn on or off the fan or connect power to the electrical connector. The controller may switch a switch in response to a signal from a sensor associated with that switch. For example switching a switch associated with the second electrical connector 20A and a switch associated with the second fan in response to a signal from a sensor indicating that a full height blade has been mounted to the docking station. In one example each switch may complete a circuit connecting the power supply to a fan or electrical connector.

The docking station may have locking features to secure a blade to the docking station. In the example of FIGS. 1 and 10 the locking features are engagement members 40A, 40B, 40C and 40D which may extend from the main body 10 to engage with and secure in place a blade that is mounted to the docking station. In other examples the engagement members could be in other positions or on the support platform. In still other examples the blade may have engagement members that are to lock with locking features such as apertures or grooves on the main body or support platform.

In the example shown in FIG. 10 lower engagement members 40A, 40B are positioned to engage with and secure either a half height blade or full height blade mounted to the docking station.

Upper engagement members 40C, 40D are positioned to engage with and secure a full height blade to the docking station, but are positioned such that they do not engage a half height blade placed on the support platform. An engagement member may be associated with a sensor 150 that is to detect when the engagement member engages with a blade. In this way signals from sensors associated with the upper and lower engagement members are received by a controller 140 and the controller 140 thus determines whether a full height or half height blade is mounted to the docking station. After making this determination the controller 140 switches the switches to turn on or off the relevant fans and electrical connectors. The controller 140 may be a simple electronic device or simple circuitry, or a CPU. Thus the control mechanism may be implemented relatively cheaply.

FIG. 11 shows a schematic view of an example engagement member 40 and associated sensor 150 in the main body 10 of a docking station and engaging with a blade 200 mounted to the docking station. The engagement member may have a release button (not shown) that can be pressed to disengage the engagement member and release a blade so that it can be removed from the docking station. In other examples there may be fewer sensors and the sensors may have different positions and/or may be independent of any engagement member or locking feature. Mechanical, optical or other sensors could be used. In still other examples engagement members of the docking station or engagement members of the blade may directly mechanically switch a switch when a blade is mounted in order to turn on the fans or power to the electrical connectors.

FIG. 12 shows an example of a rear side of the main body 10 of the docking station. The rear side includes a plurality of communication interfaces that enable the docking station to send and/or receive signals from external devices other than a blade which is mounted to the docking station. The communication interfaces are not limited to, but may include, any of the following: USB port 310, graphic ports such as High Definition Multimedia Interface (HDMI) 320 d Super Video Graphics Array (SVGA) 330 or Digital Video interface (DVI), and network ports 340 such as an Ethernet port 340 and a Network Fiber port 350. The rear side may also include any, or all, of a power connection to receive power, an on/off button 370 and a reset button 380. In the illustrated example, the rear side also has an inlet or outlet for a fan 110 which acts as part of the cooling system.

An of the features disclosed in this specification (including any accompanying claims, abstract and drawings, may be combined in any combination, except combinations where at least some of such features are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A docking station for a blade computing device comprising:
a main body housing a power supply and a cooling system;
a communication interface to connect the docking station to an external device and an electrical connector to connect to a blade computing device; and
a support platform extending outside of the main body and having a surface to support the blade computing device when the blade computing device is connected to the electrical connector;
wherein the docking station is portable.

2. The docking station of claim 1 wherein the support platform is retractable against the main body or into the main body.

3. The docking station of claim 1 wherein there are stabiliser feet on first and second sides of at least one of the main body and the support platform.

4. The docking station of claim 3 wherein the stabiliser feet are formed of a material which has a density greater than a density of the main body.

5. The docking station of claim 3 wherein each stabiliser foot has a width equal to at least 25% of a width of the main body.

6. The docking station of claim 1 wherein the support platform is such that when the blade computing device is placed on the surface of the support platform, the blade computing device is substantially exposed to an external environment.

7. The docking station of claim 1 including a locking feature to mechanically secure the blade computing device to the docking station.

8. The docking station of claim 1 wherein the cooling system includes a fan and a cooling pipe that is in communication with an aperture in an external wall of the main body and wherein the fan is to suck or blow air through the cooling pipe.

9. The docking station of claim 1 wherein the cooling system includes a first fan and a second fan and the docking station includes circuitry to detect whether a full height blade computing device or half height blade computing device is mounted to the docking station and to turn on the first fan in response to detecting that a half height blade computing device is mounted to the docking station and to turn on both the first fan and the second fan in response to determining that a full height blade computing device is mounted to the docking station.

10. The docking station of claim 9 wherein the circuitry includes a sensor to detect mounting of a full height blade computing device and a switch that is to turn from an OFF state to an ON state in response to the sensor detecting mounting of the full height blade computing device.

11. The docking station of claim 1 wherein the electrical connector is a first electrical connector to connect with an electrical connector of a half-height blade computing device or to connect with a first electrical connector of a full height blade computing device; and wherein the docking station further comprises a second electrical connector to connect with a second electrical connector of the full height blade computing device and a first electrical switch which is to connect the power supply to the first electrical connector and a second electrical switch which is to connect the power supply to the second electrical connector; the first electrical switch being switchable by mounting the half height blade computing device to the main body and both the first and second electrical switches being switchable by mounting the full height blade computing device to the main body.

12. A docking station for a blade computing device; the docking station comprising:
a power supply;
a receiving portion to receive a blade computing device;
a cooling system to cool the blade computing device;
a communications interface to connect the docking station with an external device other than the blade computing device;
an electrical connector to connect with the blade computing device, the electrical connector being connected with at least one of the power supply and the communications interface,
wherein the docking station is not capable of supporting more than one full height blade computing device.

13. The docking station of claim 12 wherein the cooling system comprises a fan and a cooling channel that has one end proximate to the fan and another end proximate the receiving portion of the docking station.

14. The docking station of claim 12 comprising a sensor to detect when the blade computing device is mounted to the docking station and circuitry that in response to the sensor detecting the blade computing device is to at least one of:
cause the docking station to supply power to the blade computing device and turn on the fan.

15. The docking station of claim 12 wherein docking station is able to support a half-height blade computing device instead of a full height blade computing device.
